(19) United States
(12) Patent Application Publication
(10) Pub. No.: US 2013/0135149 A1
(43) Pub. Date: May 30, 2013

(54) BROADBAND PRINTED ANTENNA

(71) Applicants: CHING-HSIANG KO, New Taipei (TW); Kai Shih, New Taipei (TW); Jia-hung Su, New Taipei (TW)

(72) Inventors: CHING-HSIANG KO, New Taipei (TW); Kai Shih, New Taipei (TW); Jia-hung Su, New Taipei (TW)

(73) Assignee: Cheng Uei Precision Industry Co., LTD., New Taipei City (TW)

(21) Appl. No.: 13/304,606

(22) Filed: Nov. 25, 2011

(51) Int. Cl. H01Q 1/38

(52) U.S. Cl. 343/700 MS

(57) ABSTRACT

The present invention discloses a broadband printed antenna used in a notebook for receiving and emitting electromagnetic wave signals. The broadband printed antenna includes a substrate and a conductive layer formed on a front face of the substrate. The conductive layer includes a feeding portion for transmitting electromagnetic wave signals, a radiation portion extending leftward along an end of the feeding porting, a short portion being bent and spiral and extending rightward along the end of the feeding portion, and a ground portion extending along the short portion. The present invention includes the short portion being bent and spiral at the right side of the feeding portion for compensating a band of the notebook so that the band can reach 2.3 GHz-2.7 GHz, thereby meets various requirements of communication standards.

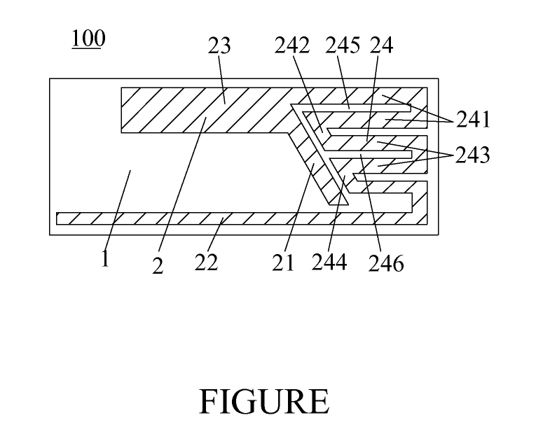

### TECHNICAL FIELD OF THE INVENTION

The present invention relates to a field of communication apparatus, more particularly, to a broadband printed antenna, which has a limited size and is able to meet various requirements of communication standards.

### BACKGROUND OF THE INVENTION

As high technical communication industry gets flourishing, mobile communication applications are applied widely, especially a so-called 4G communication becomes more and more popular. Therefore, the requirement for the frequency band used by an antenna of the mobile communication device such as a cell phone and notebook is getting higher. In the wireless communication, an antenna may have a poor communication effect due to an overly small size thereof. However, a current technical product, particularly a notebook computer, becomes more and more compact, resulting in an area of the antenna must be reduced. The notebook computers aim at a group of users with high mobility, the design thereof focuses on convenience of carrying, and therefore the size is restricted, and the antenna is limited by the exterior size of the main body, for example, the optimal usage area of the antenna is limited.

Furthermore, the antenna often generates resonance shifts of various intensities when the mobile communication device is in use. Such resonance frequency shifts must be compensated through a bandwidth. That is, an actual bandwidth of the antenna has to be wider than a designed bandwidth. However, it is usually necessary to increase an area of a radiation region in the antenna in order to increase the bandwidth. Thus, how to manufacture a broadband antenna matching the notebook computer to meet the requirements of various communication standards under a condition that the space is limited is a problem to be solved by skilled persons in this field.

Therefore, there is an imperative need for a small-sized broadband printed antenna which is able to meet various requirements of communication standards.

### SUMMARY OF THE INVENTION

Aiming at the above shortcoming of the prior arts, an objective of the present invention is to provide a broadband printed antenna, which has a small size and is able to meet various requirements of communication standards.

To reach the above objective, the present invention provides a broadband printed antenna for receiving and emitting electromagnetic wave signals. The broadband printed antenna comprises a substrate and a conductive layer formed on a front face of the substrate. The conductive layer comprises a feeding portion for transmitting the electromagnetic wave signals, a radiation portion formed to extend leftward along an end of the feeding portion, a short portion bent rightward to be spiral and extends along the end of the feeding portion, and a ground portion formed to extend along the short portion.

### BRIEF DESCRIPTION OF THE DRAWINGS

The FIGURE is a schematic diagram showing a structure of a broadband printed antenna of the present invention.

### DETAILED DESCRIPTION OF THE INVENTION

For recounting technical contents, structural features, and realized objectives and effects of the present invention, the following embodiment is described in detail with reference to appending drawing.

With reference to the FIGURE, a broadband printed antenna 100 of the present invention is used in a notebook computer for receiving and emitting electromagnetic wave signals. The broadband printed antenna 100 comprises a substrate 1 and a conductive layer 2 formed on a front face of the substrate 1. The conductive layer comprises a feeding portion 21 for transmitting the electromagnetic wave signals, a radiation portion 23 formed to extend leftward along an end of the feeding portion 21, a short portion 24 bent rightward to be spiral and extends along the end of the feeding portion 21, and a ground portion 22 formed to extend along the short portion 24. In particular, a width of the radiation portion 23 is wider than a width of the short portion 24, and the width of the short portion 24 is wider than that of the ground portion 22. The whole conductive layer is a plated copper layer. A controllable frequency range of the radiation portion 23 is a bandwidth of 2.3 GHz-2.7 GHz.

Preferably, the ground portion 22 is distributed along a lowest end of the substrate 1, and the radiation portion is disposed in parallel to the ground portion 22.

Preferably, the short portion 24 comprises a first bent arm 241 formed to be bent rightward and spiral along the feeding portion 21, a first joining art 242 bent downward along the first bent arm 241, a second bent arm 243 formed to be bent rightward and spiral from the first joining art 242, a second joining arm 244 bent downward along the second bent arm 243, a first slot 245 formed due to the first bent arm 241 being bent and spiral, and a second slot 246 formed due to the second bent arm 243 being bent and spiral. In particular, the feeding portion 21 is disposed on the substrate in a manner of inclining toward the upper-left direction, and the first bent arm 242 and the second bent arm 244 are disposed in parallel to the feeding portion 21. Such a bending manner leads to the maximum bending length of the short portion 24 in an effective area, thereby expend a high frequency band of the notebook computer.

With reference to the FIGURE, in operation, signals of different bands enter into the radiation portion 23 from the feeding portion 21, and the signals in a band (e.g. 2.3 GHz-2.7GHz) are radiated by the radiation portion 23.

As described, the antenna of the present invention comprises the short portion 24 bent and spiral at the right side of the feeding portion 21, to compensate the frequency band of the notebook, so that the band is able to reach 2.3 GHz-2.7 GHz, thereby meet various requirements of communication standards.

What is claimed is:

1. A broadband printed antenna for receiving and emitting electromagnetic wave signals, the broadband printed antenna comprising a substrate and a conductive layer formed on a front face of the substrate, the conductive layer comprising a feeding portion for transmitting electromagnetic wave signals, a radiation portion extending leftward along an end of the feeding porting, a short portion being bent and spiral and extending rightward along the end of the feeding portion, and a ground portion extending along the short portion.

2. The broadband printed antenna as claimed in claim 1, wherein the ground portion is distributed along a lowest end of the substrate.

3. The broadband printed antenna as claimed in claim 2, wherein the radiation portion is disposed in parallel to the ground portion.

4. The broadband printed antenna as claimed in claim 1, wherein the short portion comprises a first bent arm bent rightward and spiral along the feeding portion, a first joining art bent downward along the first bent arm, a second bent arm bent rightward and spiral from the first joining art, a second joining arm bent downward along the second bent arm, a first slot formed due to the first bent arm being bent and spiral, and a second slot formed due to the second bent arm being bent and spiral.

5. The broadband printed antenna as claimed in claim 4, wherein the first joining arm and the second joining arm are disposed in parallel to the feeding portion.

6. The broadband printed antenna as claimed in claim 5, wherein the feeding portion is disposed to incline toward an upper-left direction on the substrate.

7. The broadband printed antenna as claimed in claim 1, wherein the conductive layer is entirely a plated copper layer.

8. The broadband printed antenna as claimed in claim 1, wherein a width of the radiation portion is wider than a width of the short portion, and the width of the short portion is wider than a width of the ground portion.

9. The broadband printed antenna as claimed in claim 1, wherein a controllable frequency range of the radiation portion is a band of 2.3 GHz-2.7 GHz.
